(19) United States
(12) Patent Application Publication
(10) Pub. No.: US 2026/0279194 A1
(43) Pub. Date: Sep. 17, 2026

(54) METHOD FOR THE IDENTIFICATION, TRIAGING, AND ALERTING OF TRAFFIC ANOMALIES AT INTERSECTIONS

(71) Applicant: ITERIS, INC., SANTA ANA, CA (US)

(72) Inventors: ENRIQUE DANIEL SALDIVAR CARRANZA, LAFAYETTE, IN (US); MASOUD HAMEDI, POTOMAC, MD (US)

(21) Appl. No.: 19/567,945

(22) Filed: Mar. 16, 2026

Related U.S. Application Data
(60) Provisional application No. 63/771,893, filed on Mar. 14, 2025.

(51) Int. Cl. G08G 1/01; G08G 1/04; G08G 1/048; G08G 1/081

(52) U.S. Cl. CPC G08G 1/0133; G08G 1/0112; G08G 1/012; G08G 1/0129; G08G 1/04; G08G 1/081; G08G 1/048

(57) ABSTRACT

A framework for analyzing traffic conditions within a transportation infrastructure network identifies improvement opportunities in safety and efficiency at traffic intersections when abnormal events occur. The framework utilizes historical traffic condition and signalized intersection performance measurements to derive a baseline model of typical operations by day-of-week (DOW) and time-of-day (TOD). An anomaly detection threshold is derived as the minimum difference between the baseline model and current traffic performance estimations required to identify a degrading condition. The reliability of traffic conditions is verified using a coefficient of spread before a new event is classified as an anomaly. Detected anomalies are processed through an AI-based triaging approach that assigns severity levels and identifies temporal and spatial clusters of anomalies to enable prioritization of remedial measures across the transportation network.

### CROSS-REFERENCE TO RELATED PATENT APPLICATION(S)

This patent application claims priority to U.S. provisional patent application 63/771,893, filed on Mar. 14, 2025, the contents of which are incorporated in its entirety herein. In accordance with 37 C.F.R. § 1.76, a claim of priority is included in an Application Data Sheet filed concurrently herewith.

### FIELD OF THE INVENTION

The present invention relates generally to the fields of transportation infrastructure and associated management thereof. More specifically, the present invention relates to an approach to detecting abnormal traffic conditions at traffic intersections across a transportation network, and generating meaningful alerts to stakeholders upon detection of such anomalies.

### BACKGROUND OF THE INVENTION

Traffic signals have a critical role in the operation of road transportation networks. Each year transportation agencies spend billions in planning, design, construction, operation, and maintenance of signalized intersections. However, traffic signals still contribute up to 10% of all traffic delay, representing a significant cost at least in terms of lost productivity in urban areas.

Transportation networks typically comprise a large number of intersections that are managed by transportation agencies. This volume alone makes it difficult to promptly detect when traffic conditions at a particular location significantly differ from usual operation. If anomalies were detected as they occur, mitigation actions could be taken proactively to improve safety and operations of both the affected intersection and the broader transportation network as a whole. The existing art lacks efficient signal performance monitoring techniques that are able to identify specific locations suffering from degrading anomalies where immediate actions such as re-timing, detours, or longer-term capital investment, would enhance operations.

Current approaches to identifying traffic anomalies focus on the evaluation of data quality, roadway conditions, traffic law compliance, and pedestrian behavior. However, the existing art provides very few techniques for earlier detection of traffic condition anomalies and for estimating their severity and impact on intersection performance, particularly at specific locations within transportation networks.

The current state of the art in traffic anomaly detection includes techniques that use detector-based Automated Traffic Signal Performance Measures (ATSPMs) data to identify anomalies on the quality of the data itself (i.e., missing data, data shifting, etc.). Road segment traffic anomalies have also been detected using a variety of different approaches, for example computer vision (i.e. through the use of data collected by cameras) that is able to identify traffic anomalies, such as traffic violations and abnormal pedestrian behavior.

High-resolution, crowdsourced connected vehicle (CV) trajectory datasets, which provide descriptive and geospatial information of traveling vehicles, have recently become commercially available. Yet the current state of the art remains limited in usage of such data for identifying anomaly mitigation needs that would reduce congestion, vehicle stops, and delays, while also improving safety and mobility.

While CV trajectory datasets provide agencies with the ability to evaluate operational traffic signal performance near real-time at thousands of intersections, because of the large coverage that is provided by these datasets, it can be difficult for practitioners to identify live degrading conditions that can benefit from mitigation activities. Different techniques exist in the art that utilize several days or weeks of traffic signal performance results at scale to suggest locations where increased capacity or improved coordination is likely to enhance efficiency. However, these techniques focus on the analysis of trends that indicate inefficiencies and are not designed to highlight locations with rapidly degrading conditions.

There remains a significant and unmet need for an infrastructure-wide approach that utilizes traffic signal performance measures derived from detector data, segment-based probe vehicle data, or crowdsourced CV trajectory data (or a combination of these) to promptly identify anomalies and triage for mitigation activities. Intersection performance metrics can now be derived from many different types of data that can be used by the methodology of the present invention disclosed below to realize more robust transportation networks.

### BRIEF SUMMARY OF THE INVENTION

The present invention addresses these limitations in the existing art in a framework that utilizes analytics from traffic performance measurements to realize improvements in safety and efficiency at intersections when abnormal events affect traffic conditions. These abnormal events can be a result of special events, adverse weather, traffic incidents, work zones, police activity, etc. The framework utilizes traffic performance metrics derived from either detector data, segment-based probe vehicle data, crowd-sourced CV trajectory data, or a combination of these, to detect anomalies and generate meaningful alerts to stakeholders.

The present invention provides a framework for a scalable approach that utilizes traffic signal performance measures to automatically detect degrading traffic anomalies that may benefit from congestion mitigation activities. Traffic signal performance under normal conditions is modeled at each intersection using historical data. If new, current estimated metrics significantly diverge from expected results under reliable traffic conditions, the event is marked as an anomaly. Once flagged, the anomaly is processed through an AI-based triaging model in an approach comprising two complementary techniques. First, a severity level is assigned to the anomaly based on its characteristics. Second, one or more clustering algorithms are applied to group anomalies both temporally and spatially. Together, these AI-based triaging techniques enable transportation agencies to prioritize the allocation of limited resources toward the most critical and impactful conditions, and to implement mitigation measures in a more targeted and timely manner.

The present invention provides at least the following benefits for transportation infrastructure and associated agencies that provide management thereof. It allows for continuous and automatic identification of traffic anomalies for each movement, approach, and/or intersection in their managed network. This may be accomplished only using CV trajectory data, probe-based data, or detector-based data, or some combination of the three. Therefore, traditional detection systems can be used but are not required. The present invention also employs an AI-based triaging model in an approach that assigns a severity indicator to each anomaly event and applies temporal and spatial clustering algorithms to group related anomalies. The severity indicator, combined with clustering, enables practitioners to filter and prioritize anomaly alerts based on both the magnitude of individual events and the presence of sustained or geographically correlated patterns of degradation. Still further, the present invention provides deeper insights to transportation agencies by providing anomaly dashboards and/or alerts that report intersections with the most anomalies and highlight clusters of co-occurring events across time and space. This can be utilized, for example, to recommend particular intersections for improvements and to identify widespread events affecting multiple locations, much faster than in the existing technology.

It is therefore one objective of the present invention to provide systems and methods of improving the performance of roadway transportation networks. It is another objective of the present invention to provide systems of methods of utilizing different types of connected vehicle, probe-related, or detector-related data to discern traffic performance measures for detecting traffic anomalies across such a roadway transportation network. It is yet another objective of the present invention to provide systems and methods for artificial intelligence-based triaging that enable transportation practitioners to prioritize anomaly response and allocate limited resources more effectively through anomaly severity estimation and the temporal and spatial clustering of anomalies. It is still a further objective of the present invention to provide systems and methods of improving roadway safety and creating more robust roadway transportation networks.

Other objectives, embodiments, features, implementations and advantages of the present invention will become apparent from the following description of the embodiments, taken together with the accompanying diagrams, which illustrate, by way of example, the principles of the invention.

### BRIEF DESCRIPTION OF THE DRAWINGS

The accompanying diagrams, which are incorporated in and constitute a part of this specification, illustrate several embodiments of the invention and together with the description, serve to explain the principles of the invention.

FIG. 1 is a systemic block diagram illustrating various components of a traffic anomaly detection framework and artificial intelligence-based triaging for use in transportation infrastructure networks, according to the present invention;

FIG. 2 is a flow diagram of steps in a process for performing anomaly detection and artificial intelligence-based triaging according to one aspect of the present invention;

FIG. 3 shows a graph that illustrates anomaly identification and severity classification according to the present invention, by providing exemplary traffic conditions;

FIG. 4 illustrates graphs of time-of-day (TOD) mapping of estimated anomalies at an exemplary intersection, by standard TOD and mapped as a unit circle;

FIG. 5 is a three-dimensional representation of anomalies that have been temporarily clustered; and

FIG. 6 is a representation of spatial clustering over a transportation infrastructure network significantly impacted by a major event.

### DETAILED DESCRIPTION OF THE INVENTION

In the following description of the present invention, reference is made to the exemplary embodiments illustrating the principles of the present invention and how it is practiced. Other embodiments will be utilized to practice the present invention and structural and functional changes will be made thereto without departing from the scope of the present invention.

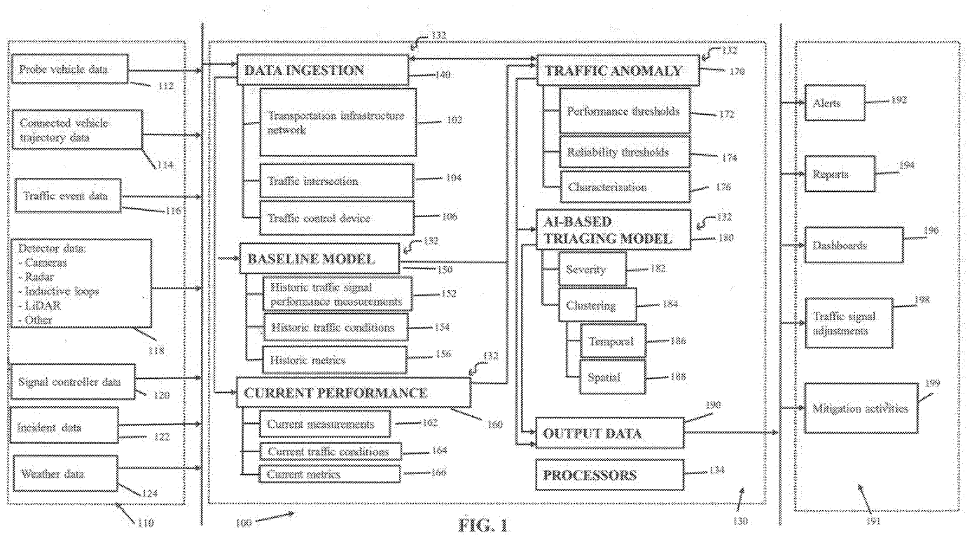

The present invention is embodied in an anomaly detection framework 100 shown in FIG. 1 that, as noted above, utilizes analytics from traffic performance measurements (such as for example those derived from detector data, segment-based probe vehicle data, crowdsourced CV trajectory data, or some or all of these types of data), to efficiently detect traffic anomalies at traffic intersections 104 within a transportation network 102 and to triage detected anomalies 170 using artificial intelligence (AI)-based models 180 that utilize techniques to perform severity classification, temporal clustering, and spatial clustering. This anomaly detection framework 100 may be embodied in one or more systems and/or methods that generate, as exemplary outputs of the processing conducting therein, alerts or dashboards that may be used to more efficiently mitigate the effect of such anomalies 170 within the transportation network 102. These systems and/or methods are therefore approaches for improving safety and performance for pedestrians, drivers, and other users of roadways within such a transportation network 102.

These systems and/or methods are performed in a plurality of data processing elements 132, or modules, that are components within a computing environment 130 that also includes one or more processors 134 and a plurality of software and hardware components. The one or more processors 134 and plurality of software and hardware components are configured to execute program instructions or routines to perform the modules, components, and functions described herein that together comprise and are embodied within the plurality of data processing elements 132. The words “module” and “modules” as used herein, may refer to logic embodied in hardware or firmware, or to a collection of software instructions, written in a programming language, such as, for example (but not limited to), Java, C, Python, or assembly. One or more software instructions in the modules may be embedded in firmware. It will be appreciated that the modules forming the data processing functions may include connected logic modules, such as gates and flip-flops, and may include programmable modules, such as programmable gate arrays or processors. Modules described herein may be implemented as either software and/or hardware modules and may be stored in a storage device. It is to be additionally understood that the data processing elements 132, and the respective components of the present invention that together comprise the specifically-configured elements, may interchangeably be referred to as “components,” “modules,” “algorithms” (where appropriate), “engines,” “networks,” and any other similar term that is intended to indicate an element for carrying out a specific data processing function.

FIG. 1 is a systemic block diagram showing various components comprising the input elements, processing elements, and output forms of the anomaly detection framework 100. The anomaly detection framework 100 includes one or more data ingest components 140 for ingesting and processing input data 110. These data ingest components 140 may be configured to ingest, receive, request, or otherwise obtain input data 110 that includes segment-based probe vehicle data 112, crowdsourced CV trajectory data 114, or other input data 110 from various types of other traffic data sensors and detectors as described below. Input data 110 from some or all of these sources are then processed in one or more data processing elements 132 that perform the analytics and algorithms described herein.

Other types of traffic data detectors may include traditional systems 118 such as cameras (which may include video cameras and thermal cameras), radar systems, inductive loop detectors, LiDAR sensors that are either on the side of a roadway, in or under the roadway, or positioned higher above traffic to observe and detect objects in a desired area, and other traditional systems such as magnetometers. Other types of input data 110 may be obtained from datasets, including controller-based datasets such as those providing high-resolution traffic signal controller data 120, and datasets from incident data providers 122, such as crash-related datasets from HERE and Waze, as well as agency crash data (whether they are from partner networks, customer networks, or internal sources). Segment-based vehicle probe data 112 and crowdsourced CV trajectory data 114 may be obtained from proprietary sources, such as for example from the ClearGuide™ traffic analytics platform and data architecture.

Regardless, the input data 110 obtained from these sources provides both historic traffic conditions 154 and signalized intersection performance measurements 152, and current traffic conditions 164 from current signal performance measurements 162, that can be analyzed to help transportation agencies monitor the healthy operation of the traffic intersections 104 in their transportation infrastructure networks 102. It is to be understood that different traffic conditions (historic and current) and metrics (historic and current) derived from signalized intersection performance measurements (historic and current) provide different levels of analytics for traffic planners. For example, metrics from these traffic conditions and signalized intersection performance measurements may be derived at different resolutions from detectors and communication equipment deployed at a traffic intersection 104, from segment-based probe vehicle data 112, or from crowdsourced CV trajectory data 114 that usually includes the location, direction of travel, and speed of sampled vehicles.

It is to be understood that metrics representing traffic conditions and signalized intersection performance measurements may be derived and provided as input data 110, and/or may be derived as an intermediate step to a baseline model 150 and the current performance estimation module 160 described herein, and/or may be derived by the baseline model 150 and the current performance estimation module 160 themselves. Therefore, neither this specification nor its claims are to be limited in any way to how and where traffic condition and signalized intersection performance measurements (both historic and current) are derived.

Regardless, examples of metrics used to evaluate traffic intersection 104 performance are, as noted herein, control delay (DLY), arrivals-on-green (AOG), and split failures (SF). Control delay measures the time lost by travelers due to a traffic control device 106 such as a traffic signal at a traffic intersection 104. Arrival-on-green estimates the ratio of vehicles that cross the traffic intersection 104 without having to stop. Split failures measure the proportion of queued vehicles that cannot discharge the traffic intersection 104 during the display of green after stopping. The anomaly detection framework 100 may detect anomalies 170 for these or metrics derived from any other estimated intersection performance measurements.

The data processing elements 132 of the anomaly detection framework 100 include the baseline model 150. The anomaly detection framework 100 of FIG. 1 of the present invention evaluates historic traffic conditions 154 and from historic metrics 156 derived from historic signalized intersection performance measurements 152 to derive the baseline model 150 of typical operations by day-of-week (DOW) and time-of-day (TOD). Any amount of such historic traffic conditions 154 and historic signalized intersection performance measurements 152 may be used to create this baseline model 150. Then, it calculates the minimum difference between the baseline model 150 and current performance metrics 166 for estimates of current performance 160 of current traffic conditions 164 from performance measurements 162 to be considered as anomalies 170 or abnormal events. If an anomaly 170 is detected, current traffic conditions 164 are reviewed to ensure the reliability of the current performance estimations 160. Finally, if current traffic conditions 164 in the new performance estimations 160 are reliable based on this feedback, the event is labeled as an anomaly 170 and one or more artificial intelligence-based triaging models 180 are applied. The process performed in these AI-based triaging models includes the estimation of the severity 182 of the anomaly 170, and the identification of clusters 184 as temporal clusters 186 and spatial clusters 188 of anomalies 170 to facilitate prioritization. Once the processes in the AI-based triaging models is complete, the information may be promptly communicated to relevant stakeholders as output data 190 to take action in one or more remedial measures 191 if needed.

The baseline model 150 and estimations of current performance 160 of the anomaly detection framework 100, together with the metrics 156 representing historic traffic conditions 154, and the metrics 166 representing current traffic conditions 164 may be derived from heuristic techniques, summary statistics, descriptive statistics, or forecasting techniques that may be based on artificial intelligence (AI) applications. The minimum difference required between the baseline model 150 and current performance estimations 160 to classify an anomaly 170 can be calculated from the historic data distribution and set thresholds.

Current traffic conditions 164 are deemed reliable when enough sampled data is available and when the coefficient of spread (CS) is below a certain reliability threshold 174. The CS is a new statistical metric that summarizes data coverage over a given range. It works by calculating the ratio of a metric's IQR (i.e., the spread measurement) (or similar) and a given range (i.e., the likely values of the metric). High values of CS indicate that measurements are widely spread, while low values of CS indicate that estimated metrics are concentrated. Other metrics that summarize data distribution, such as variance or standard deviation, may also be used. The reliability threshold 174 is therefore calculated at least in relation to the amount of data coverage and whether the CS measurements are widely spread or concentrated.

As part of the process(es) performed in the AI-based triaging model(s) 180, an anomaly 170 is assigned a severity 182 based on three variables: the deviation of the new metric from the anomaly threshold 172 as a percentage of the metric's expected range, the duration of continuous reliable traffic conditions 154 during the period in which the anomaly 170 was identified, and whether the anomaly 170 borders historic traffic conditions 154 that are considered unreliable. The AI-based triaging model(s) 180 further identify temporal clusters 186 by grouping anomalies 170 that occur in temporal proximity to each other, highlighting situations where current traffic conditions 164 significantly deviate from the baseline model 150 over prolonged periods that are likely to benefit from congestion mitigation activities. Additionally, spatial clusters 188 are identified by grouping anomalies 170 that occur at nearby traffic intersections 104 for the same DOW and TOD, indicating that performance degradation at one traffic intersection 104 is likely affecting adjacent traffic intersections 104 within the transportation network 102. This AI-based triage modeling 180 is particularly useful for transportation practitioners as it allows them to determine what level of reporting 194 they wish to obtain from the anomaly detection framework 100 and where to focus limited resources. The anomaly detection framework 100 of FIG. 1 of the present invention may be applied to any traffic signal performance measure (e.g., DLY, AOG, SF, etc.) derived from any data source (e.g., detector data 118, probe data 112, trajectory data 114, etc.).

In addition to the historic traffic conditions 154 and signalized intersection performance measurements 152 and related historic metrics 156, weather 124 (i.e., temperature and precipitation) and event 116 (e.g., crashes, hard-braking, hard-acceleration, closures, etc.) datasets may also be included to enhance the anomaly detection framework 100 and the quality of alerts 192 that are generated and are examples of actions for remedial measures 191 resulting from the application of the anomaly detection framework 100. The accuracy of performance predictions may further improve by considering the context in which vehicles travel as described by these additional datasets. Furthermore, different types of alerts 192 may be generated that also provide a description of current traffic conditions 164 that may have led to an event 116 qualifying as an anomaly 170 taking place, thereby providing an element of traceability. This information is valuable information to transportation practitioners as they attempt to mitigate degrading current traffic conditions 164.

Many other types of actions may be taken as remedial measures 191 and are within the scope of the present invention as uses of the output data 190. These may include signal adjustments 198 for a traffic control device 106, and deployment of emergency or road maintenance actions as mitigation activities 199, depending on the type of anomaly 170. Agencies may also use the anomaly detection framework 100 to generate reporting 194 or dashboards 196, either required by regulatory bodies or otherwise, as another example of output data 190.

It is to be understood that the present invention may include one or more algorithms that also characterize the anomaly 170 that has been detected from the input data 110, as well as the characteristics used in AI-based triage modeling 180. In one embodiment, the anomaly detection framework 100 of FIG. 1 may therefore also include anomaly characterization 176, where the present invention is configured to utilize one more types of input data 110 once anomaly 170 has been detected to determine why an anomaly is occurring at a particular traffic intersection 104, and provide an appropriate remedial measure 191 as output data 190. The anomaly detection framework 100 may therefore automatically request additional input data 110 via the data ingest module 140 to make this determination of anomaly characterization 176.

It is to be further understood that input data 110 such as weather 124 may include both climatological and/or meteorological short-term prediction and long-range dynamical forecasting. Camera data from detector data 118 may include data collected from unmanned aerial vehicles (UAVs) such as drones or satellites, in addition to imagery collected from fixed locations providing still images and video.

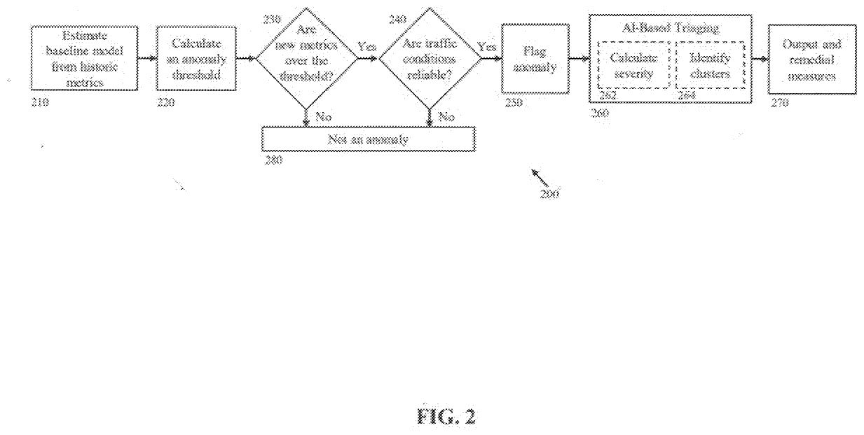

FIG. 2 is a high-level diagram showing steps of the process 200 provided in the anomaly detection framework 100 of the present invention to reliably identify traffic signal performance anomalies. The anomaly detection framework 100 includes as noted above a baseline model 150 of expected performance, estimated with historic data. Step 210 includes obtaining such historic data and initiating the baseline model 150. At step 220, the process calculates a threshold 172 for an anomaly 170 as described above.

Current estimated measurements 162 for current performance estimations 160 are captured, and at step 230 the process 200 determines if this new information exceeds the threshold 172. If an anomaly 170 is detected using the new performance estimations 160 representing current traffic conditions 164 (i.e. the threshold 172 is exceeded), and data regarding current traffic conditions 164 are deemed reliable at step 240, the current traffic conditions 164 are flagged as an anomaly 170 at step 250, its severity 182 is estimated at step 262, and temporal clusters 186 and spatial clusters 188 of clusters 184 of anomalies 170 are identified at step 264. Finally, output data 190 and remedial measures 191 are provided at step 270. If the new performance estimations 160 do not exceed the threshold 172 at step 230, and the current traffic conditions 164 are not considered reliable at step 240, the process 200 determines that there is no anomaly 170 at step 280. The process 200 may repeat until reliable current traffic conditions 164 can be established at step 240.

It is to be understood that the anomaly detection framework 100 is applicable to diverse analysis periods (e.g., 5 minutes, 15 minutes, 30 minutes, 1 hour, etc.) and at the movement, approach, and intersection levels. The anomaly detection framework 100 identifies anomalies 170 for popular CV-derived traffic condition and signalized intersection performance measurements 152, such as control delay (DLY), split failures (SF), and arrivals on green (AOG); however, the anomaly detection framework 100 of the present invention may be applied for any performance metric derived from any dataset.

The anomaly detection framework 100 obtains historic traffic signal performance measurements 152 and determines metrics 156 by calculating DOW and TOD baseline models 150. Then, it uses median absolute deviation (MAD) values (or other distribution dispersion metrics such as variance) and may further use fixed thresholds to calculate the anomaly detection thresholds 172.

In one embodiment of the present invention, and as indicated in FIG. 2, the anomaly detection framework 100 (and process 200) derives the baseline model 150 of expected signal performance under normal traffic conditions. This baseline model 150 is then used to derive an anomaly threshold 172 to assess when a current metric 166 from performance estimations 160 differs enough from expected values to warrant further investigation. Development of the baseline model 150 that is used in step 210 of the process 200 in FIG. 2 and in the anomaly detection framework 100 of FIG. 1 is discussed below.

The baseline model 150 is expressed as (Mj,k) and is calculated as the median of the DOW and TOD groups from usually six weeks of historic estimated performance results 152 (Ri,j,k). That is:

$${M}_{j , k} = {median}_{i = 1}^{6} ( {R}_{i , j , k} ) \qquad ( 1 )$$

where i∈{1, 2, . . . , 6} represents the historic week index, j∈{1, 2, . . . , 7} represents the DOW index, and k∈{1, 2, . . . , T} represents the TOD intervals (i.e., 15 minutes, 30 minutes, etc.). Therefore, for each j and k combination there are usually six values across the six weeks. Different numbers of historic weeks of data may also be used.

The baseline model 150 uses these weeks of historic data to balance data quantity and recency. The median of historic results (from equation (1) above) is used to estimate the baseline model 150 because it provides a clear and fast calculation that likely represents usual conditions. Other statistical or machine learning-based estimation techniques may also be used to estimate M.

The anomaly detection framework 100 then determines an anomaly threshold 172 for DOW j and TOD k (A_{j,k}) that represents the minimum difference required between metrics from current performance estimations 160 and the model (M_{j,k}, from equation (1)) to further consider a value as an anomaly 170. This is calculated as follows:

$$F = \{ \begin{matrix}0.15 , if SF and SF = 0 \\ 0.3 , if SF and SF > 0 \\ 0.3 , if AOG \\ 50 , if DLY\end{matrix} \qquad ( 2 )$$

$$MA {D}_{j , k} = {median}_{i = 1}^{6} ( \vert {R}_{i , j , k} - {M}_{j , k} \vert ) \qquad ( 3 )$$

so that anomaly detection threshold 172 A_{j,k} is

$${A}_{j , k} = \{ \begin{matrix}min ( {M}_{j , k} - max ( F , 2.5 \times {MAD}_{j , k} ) , {min}_{i = 1}^{6} ( {R}_{i , j , k} ) ) , if AOG \\ max ( {M}_{j , k} + max ( F , 2.5 \times {MAD}_{j , k} ) , {max}_{i = 1}^{6} ( {R}_{i , j , k} ) ) , if SF or DLY\end{matrix} \qquad ( 4 )$$

where F are fixed thresholds for the different metrics that ensure that a minimum change is observed, and MAD_{j,k} is the median absolute deviation (MAD). The anomaly threshold 172 A_{j,k} guarantees that new degrading traffic conditions 162 for a metric:
have a difference from the baseline model 150 at least as large as F,
have a difference from the baseline model 150 at least as large as 2.5 MADs, and
are at least as extreme as the most extreme historic value considered for the baseline model 150.

The purpose of the identification technique for anomalies 170 expressed in the anomaly detection framework 100 is to locate significant degrading current traffic conditions 164 to enable transportation agencies to take congestion mitigation activities 199 as remedial measures 191. Because higher SF and DLY values indicate worsening conditions, and lower AOG values represent degrading traffic signal operation, the anomaly threshold 172 is calculated differently between them as noted from equation (4).

As noted above in FIG. 2 at step 230, current metrics 166 from performance estimations 160 are further assessed to be an anomaly 170 if it is less than A_{j,k} for AOG, and if it is more than A_{j,k} for SF and DLY.

The anomaly detection framework 100 then verifies the reliability of current traffic conditions 164 at step 240. The reliability of current traffic conditions 164 during the analysis periods for the baseline model 150 M_{j,k} and new current metrics 166 from performance estimations 160 are assessed if the latter passes the threshold 172 A_{j,k}. If current traffic conditions 164 are deemed reliable at step 240 for both the baseline model 150 and the new current performance estimations 160, an anomaly 170 is finally assigned to the result 250 and its severity 182 is calculated at step 262 and clustering 184 is identified at step 264 in AI-based triaging at step 260. Output data 190 is generated and remedial measures 191 are then taken at step 270. If current traffic conditions 164 are not deemed reliable for either the baseline model 150 or the current performance estimations 160, the event is not classified as an anomaly 170 at step 280 and no further action is needed.

Historic traffic conditions 154 for the analysis period of the baseline model 150 are deemed reliable when all the following are true:
At least 90% of the requested historic data is available (this ensures that enough data is considered to estimate the baseline model 150 at step 210), and
The median number of sampled vehicle trajectories used to estimate the metrics for each DOW and TOD pair is ≥t (calculation for t described below), and
The coefficient of spread (CS) is low; for example, ≤0.20 for AOG and DLY, and ≤0.10 for SF

CS is a proposed coefficient that measures the spread of the data in relation to the expected range of values (r) and is calculated using the interquartile range (IQR) from the historic data and a given range as follows:

$$CS = \frac{IQR}{r} \qquad ( 5 )$$

$$r = \{ \begin{matrix}1 , for SF and AOG \\ 120 , for DLY\end{matrix} \qquad ( 6 )$$

Low values of CS indicate concentrated metric results, while high values of CS indicate dispersed results.

Current traffic conditions 164 for the analysis period of current metrics 166 from performance estimations 160 are deemed reliable when the number of sampled vehicle trajectories used to estimate the new metrics 166 for the DOW and TOD pair is ≥t.

The minimum number of sampled trajectories used to estimate a metric 166 needed to consider a DOW and TOD pair for an identification of anomaly 170 is denoted by t. The value of tis a function of how many intersection movements are analyzed (m) and the analysis period (p) in minutes. The value tis calculated as the maximum of the set of

$$( 5 , \frac{m \times p}{4} ) .$$

If an analysis is done at the movement level (m=1) and the analysis period is one hour (p=60), then at least 15 sampled vehicle trajectories are required to consider that DOW and TOD pair. If an analysis is done for an approach with three movements (i.e., through, left, and right) (m=3) and the analysis period is half an hour (p=30), then at least 22.5 sampled vehicle trajectories are required to consider that DOW and TOD pair.

New current metrics 166 from performance estimations 160 are flagged as an anomaly 170 at step 250 once they are identified with worse performance than its anomaly threshold 172 and reliable historic 154 and current 164 traffic conditions are confirmed at step 240. The last step before generating output data 190 is the estimation of the features of the AI-derived triaging modeling 180 that include the anomaly severity classification 262 and whether the event belongs to a cluster 264 of anomalies 170.

As noted above, an anomaly severity 182 is calculated by the anomaly detection framework 100. In this step 262, three anomaly severity levels are defined (low, medium, and high), which depend on three different variables:
Distance to anomaly threshold (% range): indicates the difference between the anomaly threshold 172 and the new estimated metric 166. The result is provided as the percentage of the distance from the new estimated metric 166 to the anomaly threshold 172 in relation to range r (Equation 5). For example, a difference of 60 sec/veh between a new current performance estimation 160 and the anomaly threshold 172 for DLY represents a 50% distance because r=120 and (60/120)×100%=50%. This value provides information on the magnitude of an anomaly.
Duration of reliable conditions (minutes): indicates the total duration that continuous model DOW and TOD pairs are deemed reliable. This value provides information on the usual volatility of historic traffic conditions 154.
Border with unreliable conditions (binary): indicator that describes whether the new estimated metric 166 borders with modeled unreliable historic traffic conditions 154.
   The table below provides definitions for different severity levels that were derived using machine learning-based algorithms for segmentation:

| | Distance to | Duration of | Border with |
|---|---|---|---|
| | anomaly | reliable | unreliable |
| | threshold | conditions | conditions |
| Severity | (% range) | (minutes) | (binary) |
| Low | ≥0% | ≥0 | Yes |
| Medium | ≥5% | ≥480 | No |
| Medium | ≥10% | ≥240 | No |
| High | ≥20% | ≥240 | No |

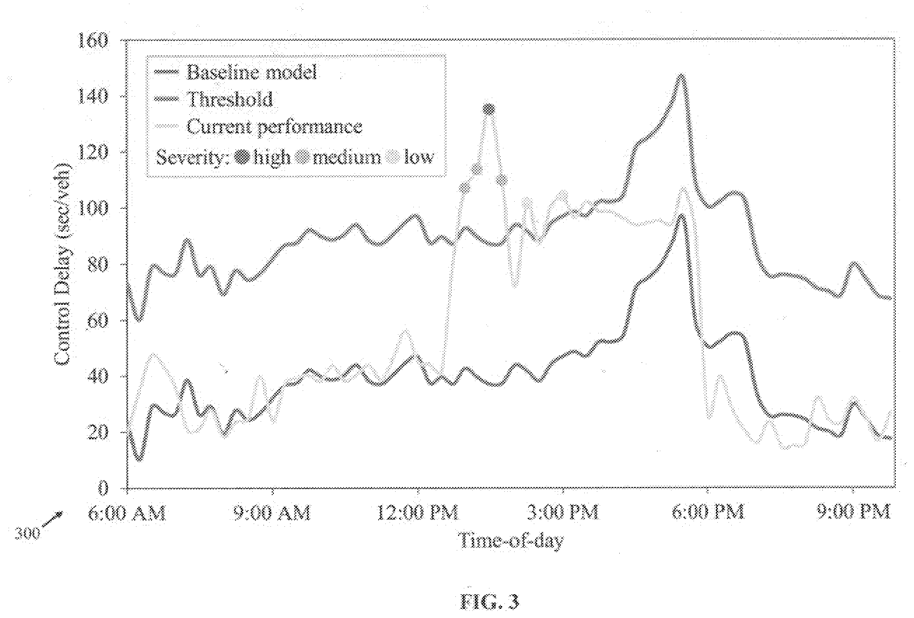

Anomaly severity 182 is conceptually demonstrated in graph 300 of FIG. 3, which shows the baseline model 150, the anomaly threshold 172, and the current performance estimation 160 for control delay for traffic signal movement. The current metrics 166 from performance estimations 160 that show worse performance than the threshold 230 and occur under reliable historic 154 and current 164 traffic conditions are traffic anomalies 170 that are highlighted with circular markers. Furthermore, the markers demonstrate their estimated severity, where the high severity period is farthest away from the anomaly threshold 172 and the low severity instances are the closest. This information is relevant for practitioners to identify locations and time periods most affected by special events.

The anomaly detection framework 100 also identifies clusters 184 at step 260. There are two types of clusters calculated in the AI-based triaging model(s) 180: temporal clusters 186 at step 262 and spatial clusters 188 at step 264. The temporal 186 clustering 184 of anomalies 170 is performed to highlight situations where current traffic conditions 164 significantly deviate from the baseline model 150 over prolonged periods. The spatial 188 clustering 184 of anomalies 170 is performed to highlight situations where current traffic conditions 164 impact a large area. Clusters identified at step 260 are more actionable instances than individual anomalies 170 because timing or route changes are more likely to be needed in order to improve operations instead of simply waiting for current traffic conditions 164 to normalize.

Temporal anomaly clusters 186 are evaluated at step 262 at the analysis level (i.e., movement, approach, or intersection) and are based on the temporal proximity at which anomalies 170 occur. The approach for the identification of temporal anomaly clusters 186 at step 262 in the process 200 in FIG. 2 is as follows:
Time-of-day mapping: since TOD resets at the end of the day, TOD needs to be mapped in a way to facilitate the identification of clusters 184 late at night and early in the morning
Density-based spatial clustering 188 of applications with noise (DBSCAN) Parameter Estimation. DBSCAN is a clustering algorithm utilized to group anomalies 170, and has two parameters to be calculated, eps and min_samples.

The first part of the approach to identify clusters 184 at step 262 is to perform time-of-day mapping by grouping all detected anomalies 170 of the different metrics over the analyzed DOW and TOD pairs. The anomaly detection framework 100 only needs to know whether a DOW and TOD pair had an anomaly 170, regardless of the quantity of metrics 166 identified with anomalies 170 or their severity 182.

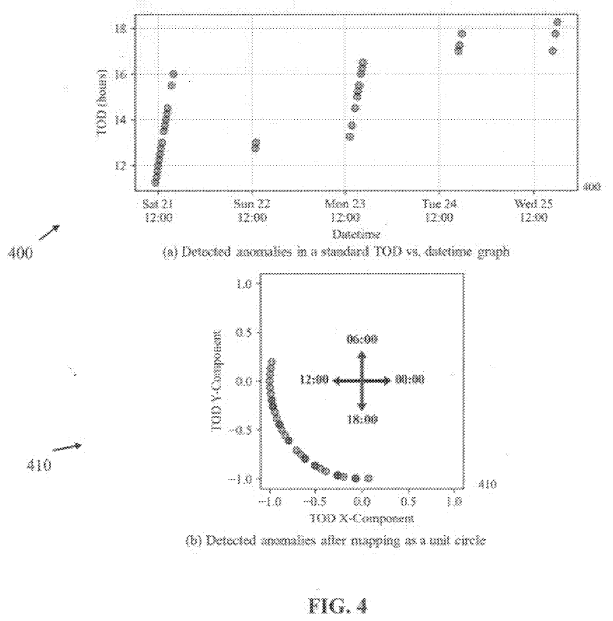

The temporal proximity between anomalies 170 is measured by considering TOD and DOW in conjunction with each other. Because of the cyclical nature of time, TOD needs to be mapped into a unit circle as follows:

$$θ ( t o d ) = 2 π \times ( t o d / 14 \; 40 ) \qquad ( 7 )$$

$$to {d}_{x} = cos ( θ ( t o d ) ) , t o {d}_{y} = sin ( θ ( t o d ) ) \qquad ( 8 )$$

$$Unit Circle Coordinates ( tod ) = ( t o {d}_{x} , t o {d}_{y} ) \qquad ( 9 )$$

where tod is the TOD in minutes, todₓ is the x-component of the mapped tod, and tod_{y} is the y-component of the mapped tod. The effects that this mapping has on the representation of anomalies 170 for a 15-minute analysis of an intersection movement is shown in the graph 400 of FIG. 4(a) (before mapping) and graph 410 FIG. 4(b) (after mapping).

Different dates of anomalies 170 are overlaid on the graph 410 of FIG. 4(b). However, anomalies 170 that occur several days apart from each other should not be considered as clusters 184 at step 264. A third dimension needs to be added to the analysis to differentiate between different dates. The approach implemented to accomplish this is explained in the DBSCAN's parameter estimation discussion below.

Two parameters are estimated for the DBSCAN implementation:
eps: the maximum distance between two samples for one to be considered as in the neighborhood of the other; and
min_samples: the number of samples in a neighborhood for a point to be considered a core point of the cluster.

Therefore, a temporal distance from an anomaly 170 is calculated that will represent a neighborhood (eps). The anomaly detection framework 100 also defines the minimum number of anomalies 170 in the neighborhood required for the events to be considered a core point of a cluster (min_samples).

The value of eps covers a common timing plan length (tpl) of 180 minutes. Then, the required eps distance in the unit circle is calculated as:

$$eps ( tpl ) = \sqrt{{( cos ( 2 π \times \frac{tp l}{1440} ) - 1 )}^{2} + {( sin ( 2 π \times \frac{tpl}{1440} ) )}^{2}} \qquad ( 10 )$$

Therefore, eps covers the distance from a given point to half tpl.

Once the value of eps is known, the different analyzed dates in the graph 410 of FIG. 4(b) can be separated. The anomaly detection framework 100 specifies how many days before or after an anomaly 170 event should be considered as part of the same cluster 184. This days-within-scope (dws) is equal to two. That means that for a giving TOD, eps should reach an anomaly 170 event that occurred on the same TOD two days before and two days after. Therefore, each consecutive date in the graph 410 of FIG. 4(b) should be separated by eps/dws.

Now that the dates in FIG. 4(b) have been separated, eps defines the radius of a sphere around each point in the graph that should be considered a neighborhood. The anomaly detection framework 100 then specifies the minimum number of anomalies required in the neighborhood to define it as a cluster 184 (min_samples). The calculation of min_samples is as follows:

$$min\_samples = steps in tpl \times tpl coverage \qquad ( 11 )$$

where steps in tpl is the total number of time steps of the analysis period that fit in the given tpl, and tpl coverage is the required coverage of anomalies 170 for the given tpl to be considered a cluster 184. For example, if the analysis period is 15-minutes, there are 12 time-step occurrences during a 180-minute tpl. Since tpl coverage is usually 0.75 (or 75%), then min_samples=12×0.75=9.

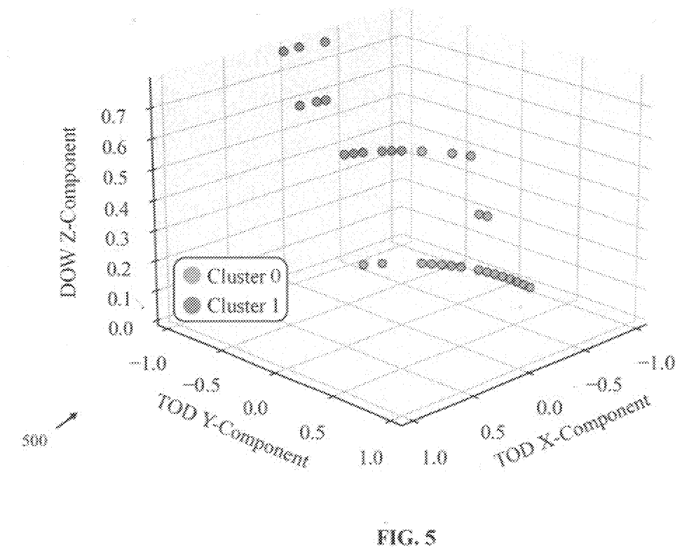

Once the anomalies 170 have been mapped to a pertinent space, and the clustering algorithm parameters (eps, min_samples) have been calculated, the anomaly detection framework 100 runs the clustering algorithm. FIG. 5 is a graph 500 that shows the effects of the date separation from FIG. 4(b) and shows the clusters assigned from the same data shown in the graphs 400 and 410 of FIG. 4.

In addition to the temporal clusters 186 described above, the anomaly detection framework 100 also identifies spatial clusters 188 at step 264 as part of the AI-based triage modeling 180. Spatial clusters 188 are identified at the intersection level and are based on the spatial proximity at which anomalies 170 occur at different traffic intersections 104 for the same DOW and TOD. Spatial clustering 188 highlights situations where performance degradation at one traffic intersection 104 is likely affecting adjacent traffic intersections 104 within the transportation network 102, enabling transportation agencies to identify broader areas of impact that may benefit from coordinated mitigation activities 199.

The spatial clustering algorithm groups traffic intersections 104 where the cost of traveling between them, measured in both travel time and travel distance, is below specified thresholds. Three parameters are used for the identification of spatial clusters 188: an influence travel distance (influence_dist), which specifies the maximum travel distance between two traffic intersections 104 for them to be considered as influencing each other; an influence travel time (influence_tt), which specifies the maximum travel time between two traffic intersections 104 for them to be considered as influencing each other; and a minimum number of intersections 104 (min_intersections), which specifies the minimum number of traffic intersections 104 in an influence neighborhood required for the group to be classified as a spatial cluster 188.

For each DOW and TOD pair, the anomaly detection framework 100 identifies traffic intersections 104 with one or more anomalies 170, regardless of the quantity of movements or approaches with anomalies 170 or their severity 182. For each such traffic intersection 104, nearby traffic intersections 104 within a scaled influence travel distance are identified. The travel time and travel distance between the traffic intersections 104 with anomalies 170 and each nearby traffic intersection 104 are then calculated. Nearby traffic intersections 104 where both the travel distance is less than or equal to the influence travel distance and the travel time is less than or equal to the influence travel time are identified as influence intersections 104. Overlapping groups of influence intersections 104 are merged together, and a spatial cluster 188 is assigned to each merged group where the total number of traffic intersections 104 meets or exceeds the minimum number of intersections 104.

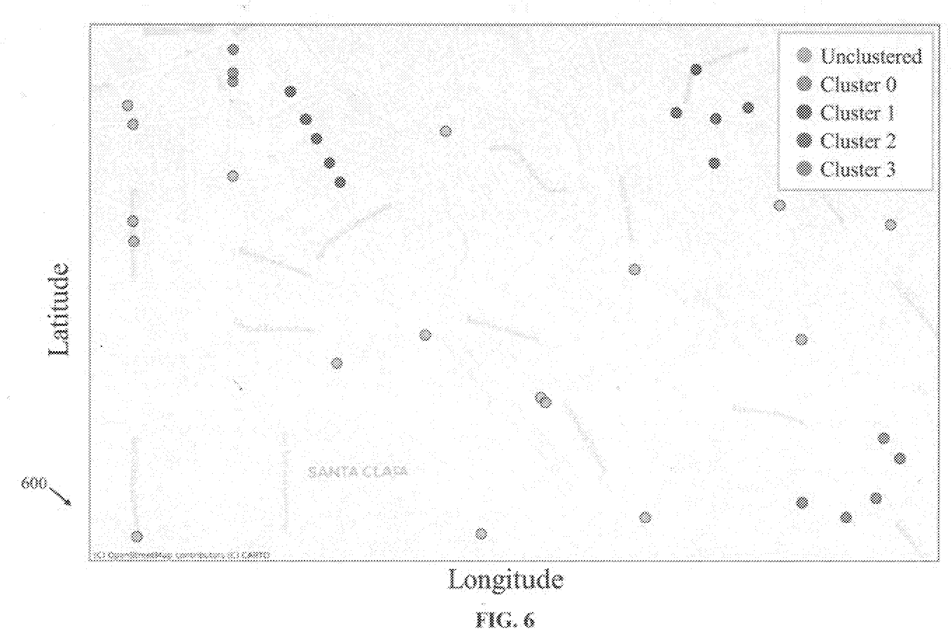

FIG. 6 is a graph 600 representing exemplary spatial clusters 188 of anomalies 170 identified across a portion of a transportation infrastructure network 102, where each spatial cluster 188 groups traffic intersections 104 experiencing anomalies 170 for the same DOW and TOD pair that are within the influence travel distance and influence travel time of each other.

It is to be understood that the values and equations expressed above are exemplary embodiments of the anomaly detection framework 100, and that other values may be applied depending on various factors, such as location, weather, usage patterns, etc. For example, more or less than 6 weeks of historic traffic performance measurements may be used for the calculation of the baseline model 150. Also, different values for determining reliability of historic 154 and current 164 traffic conditions may be utilized.

As noted above, the anomaly detection framework 100 and the AI-based triaging model(s) 180 utilize one or more machine learning techniques in making determinations about anomalies 170 in the present invention, such as for example in determining whether such anomalies 170 exist, severity 182 of anomalies 170, and identifying clusters 184. The anomaly detection framework 100 therefore includes multiple applications of artificial intelligence in the algorithms that perform the data processing functions therein. These multiple applications of artificial intelligence in the algorithms may include one or more layers of machine learning, and apply many different mathematical approaches, to analyzing information and generating outputs that improve outcomes based on the detection of anomalies 170 that are described herein.

These algorithms may apply many different techniques of machine learning, such as supervised learning and unsupervised learning, as well as one or more instantiations of neural networks to continually enhance the data modeling performed within the anomaly detection framework 100, by developing and understanding relationships between various types of information. These artificial intelligence-based applications may include standardized models, and may also include one or more models customized according to proprietary formulas. Artificial intelligence-based algorithms in the present invention may include many types of machine learning techniques. These may include, but are not limited to, k-nearest neighbor (KNN), logistic regression, support vector machines or networks (SVM), and as noted above one or more neural networks.

Neural networks generally are comprised of nodes, which are computational units having one or more biased input/output connections. Such biased connections act as transfer (or activation) functions that combine inputs and outputs in some way. Nodes are organized into multiple layers that form the neural network. There are many types of neural networks, which are computing systems that “learn” to perform tasks, without being programmed with task-specific rules, based on examples.

Neural networks generally are based on arrays of connected, aggregated nodes (or, “neurons”) that transmit signals to each other in the multiple layers over the biased input/output connections. Connections, as noted above, are activation or transfer functions which “fire” these nodes and combine inputs according to mathematical equations or formulas. Different types of neural networks generally have different configurations of these layers of connected, aggregated nodes, but they can generally be described as an input layer, a middle or ‘hidden’ layer, and an output layer. These layers may perform different transformations on their various inputs, using different mathematical calculations or functions. Signals travel between these layers, from the input layer to the output layer via the middle layer, and may traverse layers, and nodes, multiple times.

Signals are transmitted between nodes over connections, and the output of each node is calculated in a non-linear function that sums all of the inputs to that node. Weight matrices and biases are typically applied to each node, and each connection, and these weights and biases are adjusted as the neural network processes inputs and transmits them across the nodes and connections. These weights represent increases or decreases in the strength of a signal at a particular connection. Additionally, nodes may have a threshold, such that a signal is sent only if the aggregated output at that node crosses that threshold. Weights generally represent how long an activation function takes, while biases represent when, in time, such a function starts; together, they help gradients minimize over time. At least in the case of weights, they can be initialized and change (i.e., decay) over time, as a system learns what weights should be, and how they should be adjusted. In other words, neural networks evolve as they learn, and the mathematical formulas and functions that comprise neural networks design can change over time as a system improves itself.

The application of neural networks within the data modeling aspects of the anomaly detection framework 100 described herein may include instantiations of different networks for different purposes. These include both “production” neural network(s), configured to refine the algorithms performed within the overall modeling framework to generate output data, and “training” neural network(s), configured to train the production network(s) using improvements on the reasons for prior, historical outcomes that have been learned.

Neural networks can also incorporate a time delay, or feedback loop, which is calculated to generally account for temporal dependencies, to further improve the results of the modeling framework. This may be used by a particular type of neural network that accounts for timed data sequences, such as for example the Long-Short-Term-Memory (LSTM) neural network, discussed above. Feedback loops and other time delay mechanisms applied by the various mathematical functions of such a neural network are modeled after one or more temporally-relevant characteristics, and incorporate calculated weights and biases for variables depending on the input data 110 collected and type of problem being analyzed.

Supervised learning is an application of mathematical functions in algorithms that classify input data 110 to find specific relationships or structure therein that allow the baseline model 150 to efficiently produce highly accurate output data 190. There are many types of such algorithms for performing mathematical functions in supervised learning approaches. These include regression analysis (including the logistic regression discussed above, and polynomial regression, and many others), decision trees, Bayesian approaches such as naive Bayes, support vector machines, random forests, anomaly detection, etc.

Neural networks are also a type of such supervised learning approaches, which may also include one or more of the computational techniques in the algorithms described above within their structures. Neural networks are more flexible than regression approaches, and allow for combinations of both structured data (e.g., sensor data) and unstructured data (e.g., observations discerned from social media feeds or direct user input) as inputs to produce the types of outputs desired.

Recurrent neural networks are a name given to types of neural networks in which connections between nodes follow a directed temporal sequence, allowing the neural network to model temporal dynamic behavior and process sequences of inputs of variable length. These types of neural networks are deployed where there is a need for recognizing, and/or acting on, such sequences. As with neural networks generally, there are many types of recurrent neural networks. These include, for example, fully recurrent neural networks, Hopfield networks, bi-directional associative memory networks, echo state networks, neural Turing machines, and many others, all of which exhibit the ability to model temporal dynamic behavior. Any instantiation of such neural networks in the present invention may include one or more of these types, and it is to be understood that neural networks applied within the machine learning prediction engine may include different ones of such types. Therefore, the present invention contemplates that many types of neural networks may be implemented, depending at least on the nature and complexity of the input data 110 being analyzed.

The systems and methods of the present invention may be implemented in many different computing environments. For example, they may be implemented in conjunction with a special purpose computer, a programmed microprocessor or microcontroller and peripheral integrated circuit element(s), an ASIC or other integrated circuit, a digital signal processor, electronic or logic circuitry such as discrete element circuit, a programmable logic device or gate array such as a PLD, PLA, FPGA, PAL, GPU and any comparable means. Still further, the present invention may be implemented in cloud-based data processing environments, and where one or more types of servers are used to process large amounts of data, and using processing components such as CPUs, GPUs, TPUs, and other similar hardware. In general, any means of implementing the methodology illustrated herein can be used to implement the various aspects of the present invention. Exemplary hardware that can be used for the present invention includes computers, handheld devices, telephones (e.g., cellular, Internet-enabled, digital, analog, hybrids, and others), and other such hardware. Some of these devices include processors (e.g., a single or multiple microprocessors or general processing units), memory, nonvolatile storage, input devices, and output devices. Furthermore, alternative software implementations including, but not limited to, distributed processing, parallel processing, or virtual machine processing can also be configured to perform the methods described herein.

The systems and methods of the present invention may also be wholly or partially implemented in software that can be stored on a non-transitory computer-readable storage medium, executed on programmed general-purpose computer with the cooperation of a controller and memory, a special purpose computer, a microprocessor, or the like. In these instances, the systems and methods of this invention can be implemented as a program embedded on a mobile device or personal computer through such mediums as an applet, JAVA® or CGI script, as a resource residing on one or more servers or computer workstations, as a routine embedded in a dedicated measurement system, system component, or the like. The system can also be implemented by physically incorporating the system and/or method into a software and/or hardware system.

Additionally, the data processing functions disclosed herein may be performed by one or more program instructions stored in or executed by such memory, and further may be performed by one or more modules configured to carry out those program instructions. Modules are intended to refer to any known or later developed hardware, software, firmware, machine learning, artificial intelligence, fuzzy logic, expert system or combination of hardware and software that is capable of performing the data processing functionality described herein.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention be limited not by this detailed description. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A method, comprising:
obtaining input data representing historical traffic conditions and current traffic conditions at one or more traffic intersections within a transportation infrastructure network, the input data including one or more of segment-based probe vehicle data and crowdsourced connected vehicle trajectory data representing the current traffic conditions and signalized intersection performance measurements representing the historical traffic conditions;
analyzing the input data to determine anomalies at the one or more traffic intersections in one or more machine learning-based models, by:
developing a baseline model derived from the historical traffic conditions,
analyzing newly-captured measurements to determine traffic performance estimations calculated from the current traffic conditions,
determining an anomaly detection threshold which is a minimum difference between the baseline model and the traffic performance estimations calculated from historical values by day-of-week (DOW) and time-of-day (TOD) pairs to identify anomaly candidates,
determining a reliability of the historic traffic conditions when a coefficient-of-spread in the traffic performance estimations is below a reliability threshold based on a summary of data coverage over a given range,
detecting an occurrence of the anomaly at the one or more traffic intersections, and
analyzing the anomaly to determine a severity of the anomaly in one or more artificial intelligence-based triaging models; and
providing a remedial measure in response to the anomaly for the transportation infrastructure network at the one or more traffic intersections.

2. The method of claim 1, wherein the input data representing the current traffic conditions further includes detector data from one or more of camera systems, radar systems, inductive loops, and LiDAR sensors.

3. The method of claim 1, wherein the input data further includes traffic signal controller data, weather data, incident data, and event data.

4. The method of claim 1, further comprising characterizing the anomaly from one or more of the input data representing the current traffic conditions to determine an appropriate responsive remedial measure.

5. The method of claim 1, wherein the remedial measure is an action that includes one or more of generating an alert, performing a traffic signal adjustment, updating a dashboard, and implementing congestion mitigation activities such as deploying of emergency or maintenance measures at the one or more traffic intersections.

6. The method of claim 1, wherein median absolute deviation values from the historic traffic conditions relative to the DOW and TOD models are used to determine the anomaly detection threshold.

7. The method of claim 1, further comprising calculating a severity score for the anomaly based on a magnitude of a deviation of the anomaly from the anomaly detection threshold generated by the baseline model.

8. The method of claim 1, wherein the one or more machine learning-based models include performing a clustering algorithm on newly-identified anomalies to determine an occurrence of events that impact large periods and large areas at the one or more traffic intersections in temporal clusters and spatial clusters.

9. A method for detecting traffic anomalies in a transportation infrastructure network, comprising:
developing a baseline model derived from input data that includes signalized intersection performance measurements representing historical traffic conditions in a transportation infrastructure network;
analyzing newly-captured measurements representing current traffic conditions to determine traffic performance estimations from the input data, the current traffic conditions derived from one or more of segment-based probe vehicle data and crowdsourced connected vehicle trajectory data;
identifying anomaly candidates from a minimum difference between historical values for day-of-week (DOW) and time-of-day (TOD) pairs in the baseline model and the traffic performance estimations to determine an anomaly detection threshold;
determining a reliability of the historic traffic conditions when a coefficient-of-spread in the traffic performance estimations is below a reliability threshold based on a summary of data coverage over a given range;
determining that an anomaly exists in a transportation infrastructure network at the one or more traffic intersections; and
analyzing the anomaly to determine a severity of the anomaly in one or more artificial intelligence-based triaging models,
wherein a remedial measure in response to the anomaly is determined based on the deviation of the anomaly from the anomaly detection threshold.

10. The method of claim 9, wherein the input data representing the current traffic conditions further includes detector data from one or more of camera systems, radar systems, inductive loops, and LiDAR sensors.

11. The method of claim 9, wherein the input data further includes traffic signal controller data, weather data, incident data, and event data.

12. The method of claim 9, further comprising characterizing the anomaly from one or more of the input data representing the current traffic conditions to determine an appropriate responsive remedial measure.

13. The method of claim 9, wherein the remedial measure is an action that includes one or more of generating an alert, performing a traffic signal adjustment, updating a dashboard, and implementing congestion mitigation activities such as deploying of emergency or maintenance measures at the one or more traffic intersections.

14. The method of claim 9, wherein median absolute deviation values from the historic traffic conditions relative to the DOW and TOD models are used to determine the anomaly detection threshold.

15. The method of claim 9, further comprising calculating a severity score for the anomaly based on a magnitude of a deviation of the anomaly from the anomaly detection threshold generated by the baseline model.

16. The method of claim 9, further comprising one or more machine learning-based models for performing a clustering algorithm on newly-identified anomalies to determine an occurrence of events that impact large periods and large areas at the one or more traffic intersections in temporal clusters and spatial clusters.

17. A system, comprising:
one or more machine learning-based models configured to analyze input data to determine an anomaly at one or more traffic intersections, the input data representing historical traffic conditions and current traffic conditions at the one or more traffic intersections, and including one or more of segment-based probe vehicle data, and crowdsourced connected vehicle trajectory data representing the current traffic conditions, and traffic condition and signalized intersection performance measurements representing the historical traffic conditions,
wherein the one or more machine learning-based models include a baseline model derived from the historical traffic conditions; and
one or more algorithms within the machine learning-based models configured to determine a minimum difference between historical values for the day-of-week (DOW) and time-of-day (TOD) pairs derived by the baseline model and traffic performance estimations representing the current traffic conditions to determine an anomaly detection threshold, the one or more algorithms further configured to determine a reliability of the historic traffic conditions when a coefficient-of-spread in traffic performance estimations derived from the historic traffic conditions is below a reliability threshold based on a summary of data coverage over a given range,
wherein the anomaly is analyzed to determine a severity of the anomaly in one or more artificial intelligence-based triaging models, and
wherein the one or more machine learning-based models detect an occurrence of the anomaly at the one or more traffic intersections, and wherein a remedial measure in response to the anomaly for the one or more traffic intersections is taken in response to the anomaly.

18. The system of claim 17, wherein the input data representing the current traffic conditions further includes detector data from one or more of camera systems, radar systems, inductive loops, and LiDAR sensors.

19. The system of claim 17, wherein the input data further includes traffic signal controller data, weather data, incident data, and event data.

20. The system of claim 17, wherein the one or more algorithms in the one or more machine learning-based models are further configured to characterize the anomaly from one or more of the input data representing the current traffic conditions to determine an appropriate responsive remedial measure.

21. The system of claim 17, wherein the remedial measure is an action that includes one or more of generating an alert, performing a traffic signal adjustment, updating a dashboard, and implementing congestion mitigation activities such as deploying of emergency or maintenance measures at the one or more traffic intersections.

22. The system of claim 17, wherein median absolute deviation values from the historic traffic conditions relative to the DOW and TOD models are used to determine the anomaly detection threshold.

23. The system of claim 17, wherein the one or more algorithms in the one or more machine learning-based models are further configured to calculate a severity score for the anomaly based on a magnitude of a deviation of the anomaly from the anomaly detection threshold generated by the baseline model.

24. The system of claim 17, wherein the one or more algorithms in the one or more machine learning-based models are further configured to perform a clustering algorithm on newly-identified anomalies to determine an occurrence of events that impact large periods and large areas at the one or more traffic intersections in temporal clusters and spatial clusters.
